(19) United States
(12) Patent Application Publication
(10) Pub. No.: US 2015/0013199 A1
(43) Pub. Date: Jan. 15, 2015

(54) VINYL ADHESIVE GREETING CARD

(71) Applicant: Kelly Shiley, Holly Springs, NC (US)

(72) Inventor: Kelly Shiley, Holly Springs, NC (US)

(21) Appl. No.: 14/327,972

(22) Filed: Jul. 10, 2014

Related U.S. Application Data
(60) Provisional application No. 61/844,566, filed on Jul. 10, 2013.

(51) Int. Cl. B42D 15/04; G09F 1/00

(52) U.S. Cl. CPC B42D 15/045; G09F 1/00
USPC 40/124.191; 40/124.01

(57) ABSTRACT

A greeting card comprises a substrate and a vinyl. The substrate has a first side configured to receive ink such that an indicia or image can be formed on the first side and a second side. The vinyl has a first side is configured to receive ink such that an indicia or image can be formed on the first side and a second side that includes an acrylic microsphere adhesive. The second side of the vinyl is removeably adhered to the second side of the substrate, so that the second side of the substrate and the second side of the vinyl are disposed in a front and back relationship. In this relationship, the first side of the substrate and the first side of each of the one or more vinyl sheets face outwardly. In one mode, at least a portion of the vinyl is adhered to the substrate. In another mode, the portion of the vinyl is adhered to another surface. The portion of the vinyl may be transferred back and forth between the substrate and the other surface.

This application claims priority under 35 U.S.C. §119(e) from the following U.S. provisional application: Application Ser. No. 61/844,566 filed on Jul. 10, 2013. That application is incorporated in its entirety by reference herein.

### BACKGROUND

Mail correspondence remains a vital part of communication. One example of a popular method of written communication is the greeting card. Greeting cards cover a range of topics, and include cards celebrating events such as birthdays and holidays, messages of encouragement, and messages of thanks. Greeting cards may also be used to invite friends and family to events or to share personal information and news.

Often times, greeting cards include information the recipients wish to remember. For example, greeting cards may include memorable photographs or quotations the recipient wishes to enjoy. Other cards may include reminders, such as invitations or “save the date” messages. Because traditional greeting cards are comprised of various forms paper, they are not designed to be easily included in home life or decorating. Traditional methods of displaying greeting cards in the home are not always efficient for saving the information contained therein. For example, greeting cards attached to refrigerators with magnets have a tendency to fall and slide under the refrigerator if the door is opened or shut too forcefully. Cards attached to bulletin boards by thumb tacks are easily ripped off those bulletin boards when the card accidentally snag on clothing. In contrast, permanent methods of attachment, such as glue, may damage the surfaces to which the cards are attached. This is especially problematic as cards are not typically kept as a long-term part of home décor. Thus, there is a need for a durable, adhesive-based greeting card that may be removably attached to surfaces.

### SUMMARY OF THE INVENTION

The present application is directed at a vinyl adhesive greeting card. In one embodiment, a greeting card comprises a vinyl and a liner. The vinyl comprises a first side and a second side. The first side of the vinyl comprises a coating that permits ink to be adhered to the first side. The second side of the vinyl comprises an acrylic microsphere adhesive that permits the vinyl to be removably adhered to a surface. The liner comprises a first side and a second side. The first side of the liner is capable of removeably receiving the second side of the vinyl. The second side of the liner is configured to permit ink to be adhered to the second side. The second side of the vinyl is removeably adhered to the first side of the liner. The vinyl is kiss cut so that at least a portion of the vinyl may be removed from the card and removably adhered to at least one surface.

In another embodiment, a greeting card comprises a substrate having a first side and a second side. The first side of the substrate is configured to receive ink such that an indicia or image can be formed on the first side. The greeting card further comprises one or more vinyl sheets. Each of the one or more vinyl sheets has a first side and a second side. The first side of each vinyl sheet is configured to receive ink such that an indicia or image can be formed on the first side. The second side of each vinyl sheet includes an acrylic microsphere adhesive. The second side of each vinyl sheet is removably adhered to the second side of the substrate such that the second side of the substrate and the second side of each vinyl sheet are disposed in a front and back relationship, while the first side of the substrate and the first side of each of the one or more vinyl sheets face outwardly. In one mode, at least a portion of at least one vinyl sheet is adhered to the substrate. In a second mode, the portion of at least one vinyl sheet is adhered to another surface. The portion of the at least one vinyl sheet may be transferred back and forth between the substrate and the other surface.

In another embodiment, a greeting card comprises a substrate having first and second opposed sides. The first side of the substrate is configured to receive ink such that an indicia or image can be formed thereon. The second side of the substrate has one or more dedicated areas. The greeting card further comprises one or more removable vinyl sheets secured to and forming a part of the greeting card. Each vinyl sheet has first and second opposed surfaces. The first surface of the vinyl sheet is configured to receive ink such that an indicia or image can be formed thereon. The second surface of the vinyl sheet comprises an acrylic microsphere adhesive applied over a substantial portion of the second surface of the vinyl sheet. Each dedicated area of the second side of the substrate and each vinyl sheet are configured such that the vinyl sheet in one mode is adhesively secured over the dedicated area. The vinyl sheet is removable from the dedicated area and substrate such that the vinyl sheet in a second mode can be applied and secured to another surface other than a surface of the greeting card. The vinyl sheet can be moved back and forth between the dedicated area and the other surface.

### BRIEF DESCRIPTION OF THE DRAWINGS

FIG. 1 depicts a view of a greeting card, displaying a removably attachable vinyl and substrate.

FIG. 2 depicts a view of a greeting card where the kiss cut vinyl has been removed from the substrate and attached to a separate surface.

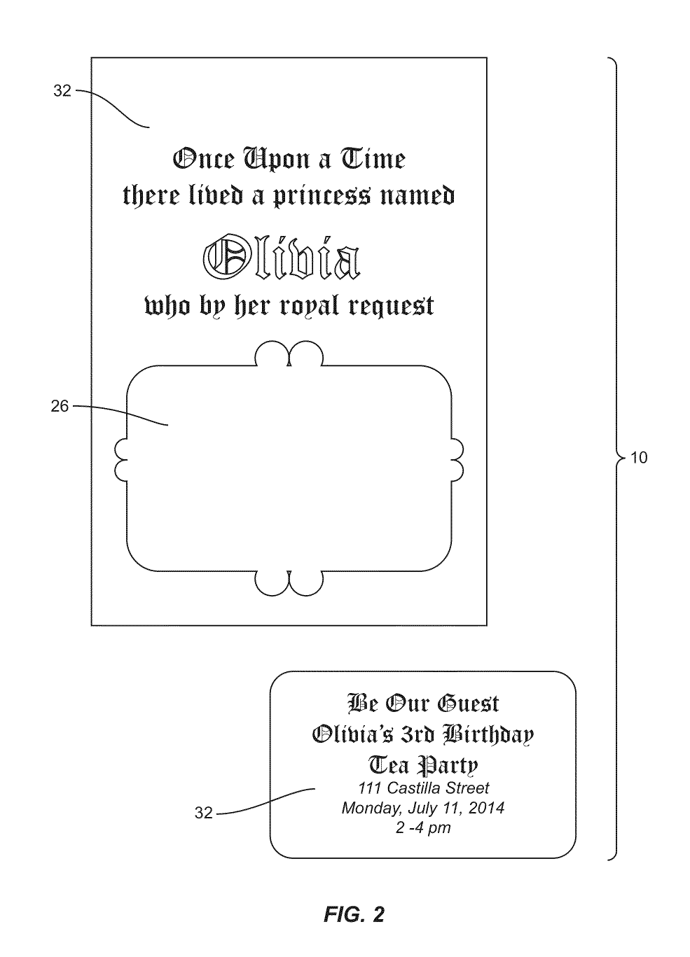

FIG. 3 depicts a greeting card, showing indicia and images printed on a vinyl, where the vinyl is kiss cut such that at least a portion of the vinyl is removably attached to a substrate.

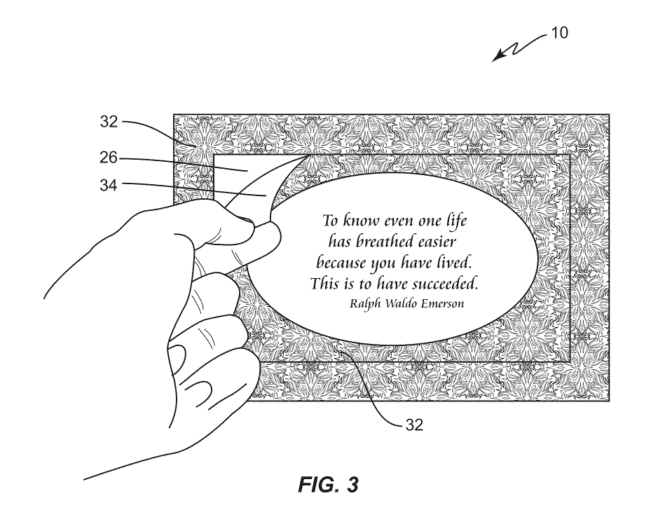

FIG. 4 depicts a greeting card, wherein a portion of the vinyl has been removed and removably attached to a flat surface.

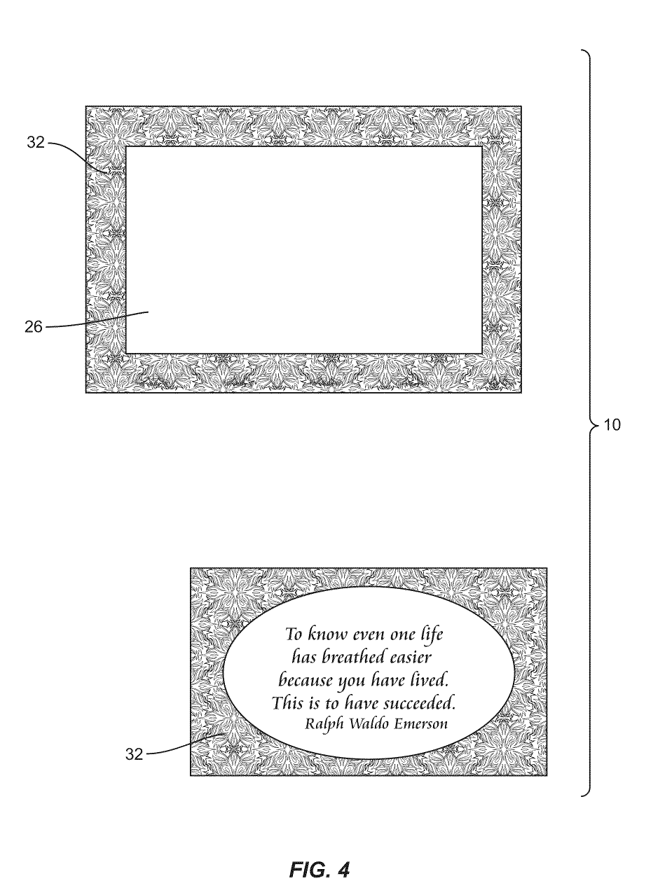

FIG. 5 depicts a folded greeting card, showing indicia and images printed on a vinyl and a substrate.

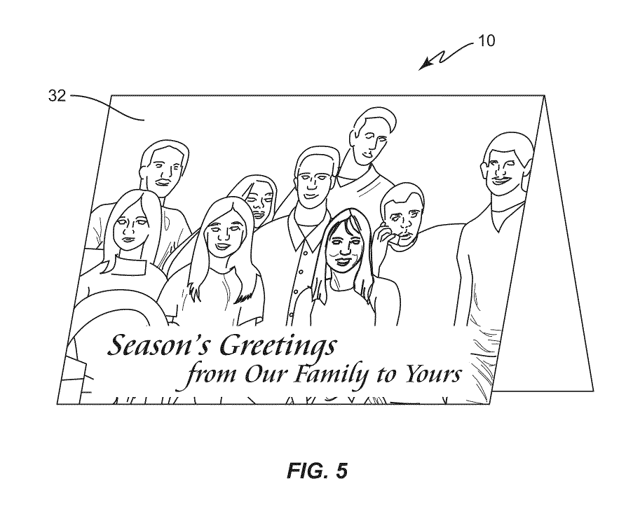

FIG. 6 depicts a folded greeting card, showing indicia and images printed on a vinyl and a substrate.

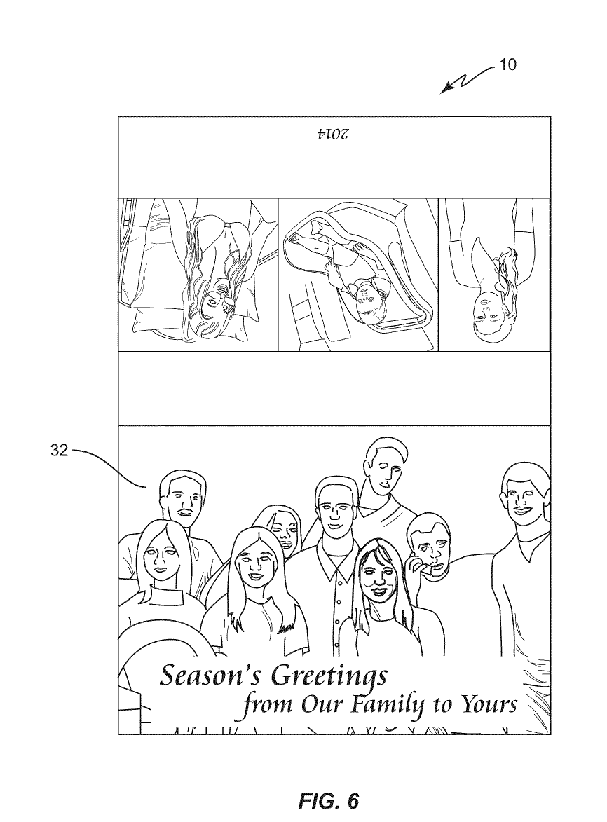

FIG. 7 depicts folded greeting card, wherein a portion of the vinyl has been removed and removably attached to a flat surface.

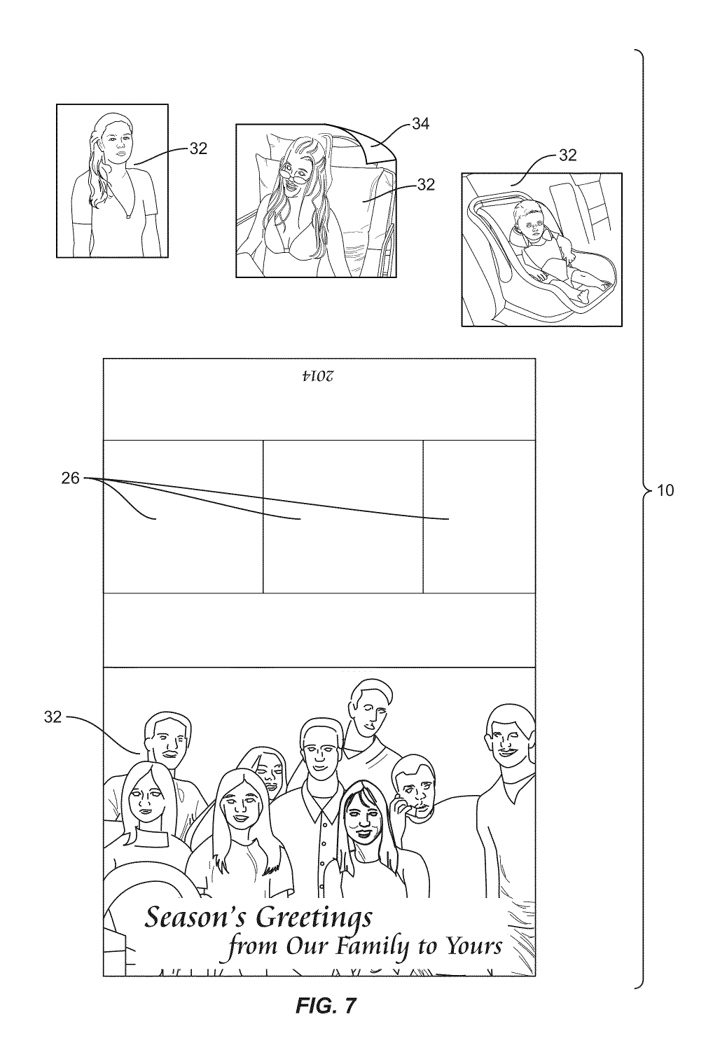

### DETAILED DESCRIPTION OF THE INVENTION

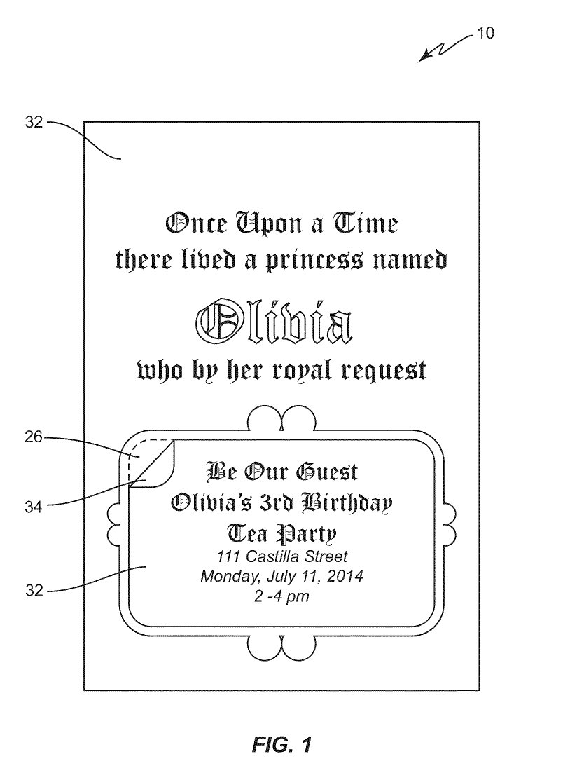

Turning now to the figures, wherein like reference numbers refer to like elements in each of the several views, FIG. 1 depicts one side of a greeting card, 10. Greeting card 10 comprises a substrate 20 and a vinyl 30.

Substrate 20 comprises a first side 22 and a second side 26. In some embodiments, substrate 20 is a liner. For example, substrate 20 may be 50#, 83#, or 90# liners in some embodiments. In another embodiment, the substrate may be an 8 pt. backer.

The first side 22 of the substrate is configured to receive ink such that an indicia or image may be formed thereon. The indicia or image may be formed by any method that allows ink to be received by the substrate. In one embodiment, the first side 22 is coated with an indigo coating to allow the indicia or image to be formed on the first side. In this embodiment, the indicia or image may be printed via an indigo press. One such press that may be used is a Hewlett Packard digital indigo press. In another embodiment, a printer may print the indicia or image directly onto the vinyl. One such press that may be used to print the indicia or image directly onto vinyl is an offset press. The indicia or image may be printed using any ink that will print to the vinyl selected.

The indicia or image may be any indicia or image that is capable of being received by the vinyl. By means of non-limiting example, the indicia or image may include artwork, photographs, text, and combinations thereof.

The second side 26 of the substrate is configured to receive a vinyl. The second side of the substrate may be comprised of any material that is capable of accepting a vinyl, where the vinyl comprises an adhesive that permits the vinyl to be removably attachable thereto.

Vinyl 30 comprises a first side 32 and a second side 34. In one embodiment, the vinyl is a 5 mm thick vinyl with an 8 pt. backer. In another embodiment, the vinyl is comprised of a tough, durable polymer.

The first side 32 of the vinyl is configured to receive ink such that an indicia or image can be formed on the first side. As with the substrate, examples of processes that allow for an indicia or image to be received by the vinyl include treatment with an indigo coating followed by printing via a Hewlett Packard digital indigo press, or direct printing via an offset press. The indicia or image on the vinyl may also be any indicia or image that is capable of being received by the vinyl, including but not limited to artwork, photographs, text, and combinations thereof.

The second side 34 of the vinyl includes an adhesive. In some embodiments, the adhesive permits the vinyl to be removed from substrate 20, repositioned, and tacked to other surfaces. The adhesive further allows for the vinyl to be removed from those other surfaces and tacked to different surfaces or back to the substrate. In one embodiment, the adhesive is an acrylic microsphere adhesive. One such acrylic microsphere adhesive that may be used is Magik-Stik™, an H-802 water based adhesive produced by Diversified Converter Materials, Inc.

The vinyl and substrate may be configured such that the second side of the vinyl 34 may be removeably adhered to the second side of the substrate. One such way to achieve this configuration is to arrange the vinyl and the substrate such that the second side of the vinyl and the second side of the liner are placed together in a front-to-back configuration. Such a configuration allows for the second side of the substrate and the second side of the vinyl to be faced against each other while the first side of the substrate and the first side of the vinyl face outwardly, i.e., in the opposing direction. This configuration also permits any indicia or image on the first side of the substrate or the first side of the vinyl to be located on the outer surfaces of the combination when the substrate and vinyl are attached together.

In some embodiments, the vinyl is kiss cut to allow at least a portion of the vinyl to be removed from the substrate. Any shape capable of being kiss cut may be utilized to create the at least a portion of the vinyl. For example, in one embodiment, a circle shape may be kiss cut onto the vinyl so that the circular portion of the vinyl may be peeled from the substrate and adhered to a flat surface.

Although the present methods have been shown and described in considerable detail with respect to only a few/particular exemplary embodiments thereof, it should be understood by those skilled in the art that it is not intended to limit the devices or methods to the embodiments since various modifications, omissions, and additions may be made to the disclosed embodiments without materially departing from the novel teachings and advantages of the methods, particularly in light of the foregoing teachings.

What is claimed is:

1. A greeting card comprising:
a substrate having a first side and a second side, wherein the first side is configured to receive ink such that an indicia or image can be formed on the first side;
one or more vinyl sheets, each of the one or more vinyl sheets having a first side and a second side, wherein the first side is configured to receive ink such that an indicia or image can be formed on the first side and the second side includes an acrylic microsphere adhesive;
and wherein the second side of each of the one or more vinyl sheets is removeably adhered to the second side of the substrate such that the second side of the substrate and the second side of the one or more vinyl sheets are disposed in a front and back relationship, and the first side of the substrate and the first side of each of the one or more vinyl sheets face outwardly; and
wherein in one mode, at least a portion of at least one or more of the vinyl sheets is adhered to the substrate, and in a second mode, the portion of the at least one or more vinyl sheets is adhered to another surface, wherein the portion of the at least one or more vinyl sheets may be transferred back and forth between the substrate and the other surface.

2. The greeting card of claim 1, wherein at least one side of the vinyl includes a coating permitting ink to be adhered to the vinyl.

3. The greeting card of claim 2, wherein the coating is an indigo coating.

4. The greeting card of claim 1, wherein the adhesive is an H-802 water based adhesive.

5. The greeting card of claim 1, wherein the vinyl is a 5 mm thick vinyl with an 8 pt backer.

6. The greeting card of claim 1, wherein the vinyl is kiss cut such that at least a portion may be removed from the card and removeably adhered to at least one surface.

7. A greeting card comprising:
a substrate having first and second opposed sides, the first side of the substrate configured to receive ink such that an indicia or image can be formed thereon;
the second side of the substrate having one or more dedicated areas;
one or more removable vinyl sheets secured to and forming a part of the greeting card;
each vinyl sheet having first and second opposed surfaces;
the first surface of the vinyl sheet configured to receive ink such that an indicia or image can be formed thereon;
the second surface of the vinyl sheet comprising an acrylic microsphere adhesive applied over a substantial portion of the second surface of the vinyl sheet;
wherein each dedicated area of the second side of the substrate and each vinyl sheet are configured such that the vinyl sheet in one mode is adhesively secured over the dedicated area; and
wherein the vinyl sheet is removable from the dedicated area and substrate such that the vinyl sheet in a second mode can be applied and secured to another surface other than a surface of the greeting card, and wherein the vinyl sheet can be moved back and forth between the dedicated area and the other surface.

8. The greeting card of claim 7, wherein the first surface of the vinyl sheet includes a coating permitting ink to be adhered to the vinyl.

9. The greeting card of claim 7, wherein the adhesive is an H-802 water based adhesive.

10. The greeting card of claim 7, wherein the vinyl is a 5 mm thick vinyl with an 8 pt backer.

11. The greeting card of claim 7, wherein a portion of the vinyl adjacent to the dedicated areas of the substrate are kiss cut such that the portion of the vinyl may be removed from the card and removeably adhered to at least one surface.
